(19) United States
(12) Patent Application Publication
(10) Pub. No.: US 2017/0217087 A1
(43) Pub. Date: Aug. 3, 2017

(54) SOLID FREEFORM FABRICATION MATERIAL, SOLID FREEFORM FABRICATION MATERIAL SET, AND METHOD OF MANUFACTURING SOLID FREEFORM FABRICATION OBJECT

(71) Applicants: Nozomu TAMOTO, Shizuoka (JP); Yasuo SUZUKI, Shizuoka (JP); Akira SAITO, Shizuoka (JP); Mitsuru NARUSE, Shizuoka (JP); Shinzo HIGUCHI, Shizuoka (JP)

(72) Inventors: Nozomu TAMOTO, Shizuoka (JP); Yasuo SUZUKI, Shizuoka (JP); Akira SAITO, Shizuoka (JP); Mitsuru NARUSE, Shizuoka (JP); Shinzo HIGUCHI, Shizuoka (JP)

(21) Appl. No.: 15/412,427

(22) Filed: Jan. 23, 2017

(30) Foreign Application Priority Data
Jan. 28, 2016 (JP) 2016-014390

(51) Int. Cl. B29C 67/00; B33Y 70/00; B33Y 10/00; B29B 9/06; B29B 9/16

(52) U.S. Cl. CPC B29C 67/0055; B29C 67/0092; B29B 9/06; B29B 9/16; B33Y 10/00; B33Y 70/00; B29B 2009/163; B29K 2105/251

(57) ABSTRACT

A solid freeform fabrication material includes a water-soluble core material and a water-insoluble coating material formed on the surface of the water-soluble core material.

### CROSS-REFERENCE TO RELATED APPLICATIONS

This patent application is based on and claims priority pursuant to 35 U.S.C. §119 to Japanese Patent Application No. 2016-014390, filed on Jan. 28, 2016, in the Japan Patent Office, the entire disclosure of which is hereby incorporated by reference herein.

### BACKGROUND

Technical Field

The present invention relates to a solid freeform fabrication material, a solid freeform fabrication material set, and a method of manufacturing a solid freeform fabrication object.

Description of the Related Art

Solid freeform fabrication technologies to laminate various materials to manufacture a solid freeform fabrication object is appealing.

The solid freeform fabrication technologies include various methods. Of these, fused deposition modeling (FDM) is relatively cost efficient with regard to devices and widely applicable because objects can be fabricated using the same material as real products.

Filament materials for use in the fused deposition modeling is classified into a modeling material for use in actual solid freeform fabrication and a supporting material to support a model (object) during fabrication (modeling). The supporting material is removed after the fabrication is complete.

Without a supporting material, freedom of the shaping and designing of a modeling object is significantly restricted. Accordingly, using a supporting material in combination is preferable.

However, while typical supporting material is suitable to support a modeling material during fabrication, removal of the supporting material after fabrication is difficult. This is one of the large factors to degrade productivity of fabricating a solid freeform fabrication object. In an attempt to solve this issue, a water-soluble supporting material has been developed. For example, a water-soluble thermoplastic composition including poly(2-ethyl-2-oxazoline) and an inert filler has been proposed.

However, the water-soluble supporting member is advantageous to easily remove the water-soluble supporting member in a short period of time but invite degradation of fabrication stability and fabrication accuracy as a large drawback because the water-soluble supporting member tends to absorb moisture.

As a means to dissolve a supporting member, not water but an alkali solution, for example, a composition including a plasticizer and a base polymer including a carboxylic acid has been proposed to dissolve the supporting member.

In this method, since the supporting member is dissolved in an alkali solution, removal of the supporting member is easy and free of the drawback of absorbing moisture in comparison with a water-soluble supporting member.

However, alkali solutions are not easy to handle and abandon, which creates a safety problem.

### SUMMARY

According to the present invention, provided is a solid freeform fabrication material includes a water-soluble core material and a water-insoluble coating material formed on the surface of the water-soluble core material.

### BRIEF DESCRIPTION OF THE SEVERAL VIEWS OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIGS. 1, 2 and 3 are diagrams illustrating an example of the method of manufacturing a solid freeform fabrication object.

The accompanying drawings are intended to depict example embodiments of the present invention and should not be interpreted to limit the scope thereof. The accompanying drawings are not to be considered as drawn to scale unless explicitly noted.

### DESCRIPTION OF THE EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result. As used herein, the singular forms “a”, “an”, and “the” are intended to include the plural forms as well, unless the context clearly indicates otherwise.

Moreover, image forming, recording, printing, modeling, etc. in the present disclosure represent the same meaning.

The embodiments of the present invention are described in detail below, but the present invention is not limited thereto.

Solid Freeform Fabrication Material

The solid freeform fabrication material in the present disclosure is used for fabricating a solid freeform fabrication object and includes a water-soluble core material and a water-insoluble coating material formed on the surface of the water-soluble core material. The solid freeform fabrication material may furthermore include optional components.

As described above,if the solid freeform fabrication material includes the core material and the coating material formed on the surface of the core material, the form of the solid freeform fabrication material is not particularly limited. For example, the solid freeform fabrication material may take various shapes such as filament, pellet, and powder. It does not matter whatever form the solid freeform fabrication material takes to demonstrate the effect of the present disclosure. In the present disclosure, for example, filament or pellet-like form is preferable. The filament represents, for example, an article formed by extruding a resin component in a string or thread-like form, which may be also called as strand.

Core Material

The core material in the present disclosure is water-soluble. More specifically, it includes a water-soluble thermoplastic resin (hereinafter referred to as water-soluble resin). The thermoplastic resin becomes soft by heating at a certain temperature or higher and changes from solid to liquid. When it is cooled down, the resin is solidified changing from liquid to solid. The water-soluble thermoplastic resin includes all of the thermoplastic resins which are liquidized partly or entirely in water when it is attached to water. In the present disclosure, the thermoplastic resin contained in the core material can be any known resins demonstrating water-solubility and thermoplasticity.

Water-Soluble Resin

The water-soluble resin for use in the present disclosure includes all the thermoplastic resin soluble in water. If the water-soluble resin for use in the present disclosure is used as a supporting material and softened upon attachment of water, removal of the supporting material is possible so that it is not always necessary for the supporting material to be dissolved in water completely. However, it is preferable that water-solubility be high because the time to be taken for removing the supporting material can be shorter if the dissolution speed is high.

Resins having hydrophilic substitution groups or structure units are examples of the water-soluble resin. Specific examples include, but are not limited to, polyvinyl alcohol resins, vinylacetate-based resins, polyalkylene oxides such as polyethylene oxide and polypropyleneoxide, polyacrylic acid-based polymers, polyvinyl pyrolidone resins, polyvinyl acetal resins, water-soluble polyamide resins, water-soluble polyester resins, cellulose resins, starch, and gelatin. If these are water-soluble, homopolymers (monopolymers), heteropolymers (copolymers), modified resins, or salts are allowed. Moreover, known functional groups can be introduced thereinto. When used as a supporting material, of these water-soluble resins, resins having a good water-soluble resin are preferable in terms of shortening the removal time of the supporting material. Therefore, polyvinyl alcohol resins and polyalkylene oxides are preferable and polyvinyl alcohol resins are particularly preferable.

Of these water-soluble resins, the temperature difference obtained by subtracting the melting point from the temperature at which 10 percent by mass of a resin is reduced by heating is preferably at least 100 degrees C. and more preferably at least 140 degrees C. The melting point represents the temperature at which a water-soluble resin is fused and melted by heat and liquidized. The melting point can be measured by various methods. In the present disclosure, the melting point can be measured according to a differential scanning calorimeter (DSC) or a differential thermal analyzer (DTA). DSC is preferable to DTA. DSC is to measure the calorie difference between a reference substance and a sample while providing a constant amount of heat and measure endothermic reaction and an exothermic reaction caused by state change of the sample. The measuring is according to JIS K7121. At this time, the temperature rising speed is 10 degrees C/min and the peak of the melting peaks is defined as the melting point.

The temperature at which 10 percent by mass is decreased by heating is the decomposition temperature of a water-soluble resin. That is, at the temperature at which 10 percent by mass is decreased, the mass of the water-soluble resin is 10 percent decreased because the molecule chain thereof is severed by heat so that the molecular weight of the water-soluble resin is reduced. Various methods are suitable to measure the temperature. In the present disclosure, thermogravimetry-differential thermal analysis (TG-DTA) is preferably used for measuring. TG-DTA is a device to continuously measure the mass change during heating of a sample and the thermal behavior of endotherm and exotherm. The measuring is according to JIS K0129. The measuring is conducted in an inert gas atmosphere such as nitrogen. The temperature rising speed is 10 degrees C/min. and the temperature at which 10 percent by mass is decreased is defined as the temperature at which 10 percent mass of the sample is reduced to the mass at room temperature.

When manufacturing a filament of the supporting member or a solid freeform fabrication object by a three-dimension object fabricating device using the supporting member, nozzle clogging caused by decomposition and solidification of the water-soluble resin contained in the supporting material can be prevented if the temperature difference obtained by subtracting the melting point of a water-soluble resin from the temperature at which 10 percent by mass is decreased is 100 degrees C. or greater. In addition, since the impact of the heat decomposition is small, fabrication can be possible at temperatures at which a suitable melt viscosity is obtained, nozzle clogging caused by viscosity increase can be also prevented. That is, it is possible to provide a supporting material which is free of fabrication error and can be quickly removed with ease from an obtained fabrication object.

If the temperature difference obtained by subtracting the melting point of a water-soluble resin from the temperature at which 10 percent by mass is decreased is less than 100 degrees C., the resin is partly decomposed during fabrication or modeling, thereby degrading the supporting property of an obtained fabrication object, which leads to deterioration of the accuracy of the fabrication object. In addition, the margin for the fusing and melting temperature is small so that nozzle clogging tends to occur and attachability to the layer below easily deteriorates. As a consequence, fabrication is not stable, which leads to many errors, degradation of the accuracy of the fabrication or modeling object, and increase of occurrence of defects.

The larger the upper limit of the temperature difference obtained by subtracting the melting point from the temperature at which 10 percent by mass of a water-soluble resin is decreased by heating, the more preferable. In terms of the properties of resins, the upper limit is normally about 200 degrees C.

As the polyvinyl alcohol resin in the present disclosure, polyvinyl alcohols including a 1,2-diol backbone in its side chain is preferable. A specific example is a polyvinyl alcohol having a 1,2 diol backbone illustrated in the following Chemical formula 1. For example, Nichigo G-Polymer series available from The Nippon Synthetic Chemical Industry Co., Ltd. as butane diol vinylalcohol polymer is suitable. Since such polyvinyl alcohol resins have low crystallinity, it has good water-solubility. When used as a supporting material, the resin can be removed in a short period of time. In addition, since the temperature difference obtained by subtracting the melting point from the temperature at which 10 percent by mass is decreased by heating, it is suitable to improve fabrication stability and fabrication accuracy in the present disclosure as described above.

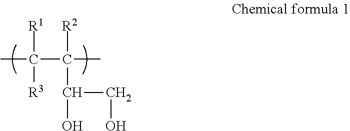

In Chemical formula 1, R1, R2, and R3 each, independently represent hydrogen or alkyl groups. The alkyl group is not particularly limited. Specific preferred examples include, but are not limited to, alkyl groups having one to four carbon atoms such as methyl group, ethyl group, n-propyl group, isopropyl group, n-butyl group, isobutyl group, and tert-butyl group. Such alkyl groups may be substituted with a substituent such as a halogen group, a hydroxyl group, an ester group, a carboxylic acid group, and a sulfonic acid group.

Moreover, the polyvinyl alcohol resin may include other structure units based on other copolymer components in addition to the structure units mentioned above. Specific examples of the structure unit based on the other copolymer components include, but are not limited to, α-olefins such as ethylene, propylene, isobutylene, α-octene, α-dodecene, and α-octadecene. The content of α-olefins mentioned above in the polyvinyl alcohol resin is preferably 0.1-10 mole percent and particularly preferable 2-8 mole percent.

Moreover, the polyvinyl alcohol resins mentioned above may include a structure unit based on other unsaturated monomers.

Specific examples include, but are not limited to, unsaturated acids such as acrylic acid, methacrylic acid, crotonic acid, maleic acid, maleic anhydride, and itaconic acid, their salts, and mono- or di-alkylesters thereof, nitriles such as acrylonitrile and methacrylonitrile, amides such as diacetone acrylamide, acrylamide, and methacrylamide, olefin sulfonic acid such as ethylene sulfonic acid, arylsulfonic acid, and metharylsulfonic acid and their salts, alkyl vinylethers, polyoxyalkylene (meth)arylether such as dimethylarylvinylketone, N-vinylpyrolidone, vinyl chloride, vinylidene chloride, polyoxyethylene(meth)arylether, and polyoxypropylene(meth)arylether, polyoxyalkylene(meta)acrylate, such as polyoxyethylene(meth)acrylate, and polyoxypropylene(meth)acrylate, polyoxyalkylene(meth)acrylamide such as polyoxyethylene(meth)acrylamide, and polyoxypropylene(meth)acrylamide, polyoxyethylene(1-(meth)acrylamide-1,1-dimethylpropyl)ester, polyoxyethylene vinylether, polyoxypropylene vinylether, polyoxyethylene arylamine, polyoxypropylene arylamine, polyoxyethylene vinylamine, and polyoxypropylene vinylamine.

Specific examples of the other unsaturated monomer include, but are not limited to, cationic group including monomers such as N-acrylamidemethyltrimethyl ammonium chloride, N-acrylamide ethyltrimethyl ammonium chloride, N-acrylamide propyltrimethyl ammonium chloride, N-acrylamide propyltrimethyl ammonium chloride, 2-acryloxyethyltrimethyl ammonium chloride, 2-methacryloxyethyltrimethyl ammonium chloride, 2-hydroxy-3-methacryloyloxypropyltrimethyl ammonium chloride, aryltrimethyl ammonium chloride, metharyltrimethyl ammonium chloride, 3-butanetrimethyl ammonium chloride, dimethyldiaryl ammonium chloride, and diethyldiaryl ammonium chloride, and acetoacetyl group-containing monomers.

Examples of metal salts for use in saponification are alkali metal salts and alkali earth metal salts. In terms of improvement on melt-formability, specific examples of the alkali metal salt include, but are not limited to, potassium salts or sodium salts of organic acids such as acetic acid, propionic acid, butyric acid, lauric acid, stearic acid, oleic acid, and behenic acid, and inorganic acids such as sulfuric acid, sulfurous acid, carbonic acid, and phosphoric acid.

Specific examples of the alkali earth metal salt include, but are not limited to, calcium salts or magnesium salts of organic acids such as acetic acid, propionic acid, butyric acid, lauric acid, stearic acid, oleic acid, and behenic acid, and inorganic acids such as sulfuric acid, sulfurous acid, carbonic acid, and phosphoric acid.

In addition, the average polymerization degree (measured according to JIS K6726) of the polyvinyl alcohol resin is 200-1,800, preferably 300-1,500, and more preferably 300-1,000. When the average polymerization degree is too high, melt viscosity is high, thereby degrading the fabrication stability. When the average polymerization degree is too low, mechanical strength of the fabricated supporting material may be short.

In addition, saponification degree (measured according to JIS K 6726) of the polyvinyl alcohol resin is not particularly limited and selected to suit to a particular application, solubility, moisture resistance, etc. In the present disclosure, partial saponification of 90 mole or less percent is preferable to complete saponification type. In the case of complete saponification type, fabrication stability or the removal efficiency of a supporting material may deteriorate due to defective discharging caused by nozzle clogging or degradation of water-solubility.

The structure unit illustrated by the Chemical formula 1 of the polyvinyl alcohol resin including a 1,2-diol backbone in its side chain accounts for 1-15 mole percent, preferably 2-10 mole percent, and more preferably 3-9 mole percent. When the mole percent of the structure unit illustrated by the Chemical formula 1 is excessively high, it is not easy to obtain a polyvinyl alcohol resin having a desired degree of polymerization. When the mole present is excessively low, the melting point is too high, which is close to the heat decomposition temperature. For this reason, burning, gel, or fish eye due to heat decomposition during melt-forming tends to be easily formed.

The water-soluble resin may furthermore optionally include other components. For example, plasticizers, fillers, stiffeners, stabilizers, flame retardants, foaming agents, antistatic agents, coloring agents, pigments, and various polymer modifiers are suitable. In addition, alloyed material obtained by mixing two or more polymer materials can be used.

Coating Material

The coating material is water-insoluble and thermoplastic. If the coating material is formed on the surface of the core material, it can serve as the coating material for use in the present disclosure. The water-insoluble thermoplastic resin (hereinafter referred to as water-insoluble resin) is not dissolved in water when it is attached to water. It includes all of the thermoplastic resins which are not liquidized partly or entirely in water when attached to water.

Water-Insoluble Resin

In the present disclosure, the thermoplastic resin contained in the coating material can be any known resins demonstrating water-insolubility and thermoplasticity. Since the coating material is formed on the surface of the core material, it is possible to reduce the moisture absorbing speed by the core material. That is, moisturization prevention is obtained.

Of these water-insoluble resins, resins having a low degree of evaporation transmission are preferable. Such resins ameliorate moisturization prevention, which is preferable for the present disclosure. Specific examples include, but are not limited to, polytetrafluoroethylene, polychlorotrifluoroethylene, polyethylene, polypropylene, nylon 11, nylon 12, nylon 66, polyethylene terephthalate, polyester, polyvinylchloride, polycarbonate, acrylic resins, polymers of ethylene and acrylic acid, polyurethane resins, and acrylic and urethane resins.

Such water-insoluble resins are water-insoluble after it is formed on the surface of a core material. It is not necessarily water-insoluble in the step of the film forming. In addition, a water-insoluble resin used as the coating material for use in the present disclosure preferably has a hydrophilic group to prevent peeling off of the coating material from the core material.

In the present disclosure, the melting point of the core material mentioned above is preferably equal to or higher than the melting point of the core material mentioned above. This is because, when the solid freeform fabrication material is used as a supporting material, the moisturization prevention of the core material is sustained before fabrication, i.e., before heating and melting since the coating material is formed on the surface of the core material. In the step of fabricating an object by heating and fusing the solid freeform fabrication material and discharging it from a nozzle for lamination by using a solid freeform fabrication device, the coating material is fused not later than the core material. Therefore, after the solid freeform fabrication material is discharged from a nozzle, the coating material is removed from the surface of the solid freeform fabrication material and merged into the inside of the core material. As a consequence, moisturization prevention is lost from the surface of the fabricated supporting material, thereby increasing water-solubility. Therefore, due to immersion in water, the supporting material is easily and quickly removed from the solid freeform fabrication object. Accordingly, since the solid freeform fabrication material has moisture prevention as the supporting material before fabrication, fabrication stability and fabrication accuracy can be prevented from deteriorating caused by moisture absorption. After the fabrication, the moisturization prevention property is lost so that the time to be taken to remove the supporting material is shortened simultaneously.

When the melting point of the core material is lower than the melting point of the coating material and if the fusing and melting temperature set in a solid freeform fabrication device is higher than the fusing and melting temperature of the coating material, the coating material is melted, resulting in shortening of time to be taken to remove the supporting material. However, when the fusing and melting point of the core material is higher than the fusing and melting temperature set in the solid freeform fabrication device, water solubility deteriorates, so that the time to be taken to remove the supporting material may not be well reduced.

In the present disclosure, as long as the water-insoluble coating material can be formed on the surface of the core material, any known method and device can be used. For example, a method is suitable which includes coating the surface of the core material with a liquidized composition including a resin having a hydrophilic group.

Specifically, methods of forming the water-insoluble coating material on the surface of the core material are typified into methods of coating with a solution in which a water-insoluble resin is dissolved and methods of coating with a resin emulsion including water-insoluble resin particulates. When coating with the solution, water or an organic solvent can be used. However, using an organic solvent is preferable because the core material is caused to contain water during coating in the case of using water as a solvent. When coating with the resin emulsion, water or an emulsion using an organic solvent can be used as a dispersion medium. However, using the resin emulsion using an organic solvent is preferable because water is similarly contained in the core material during coating in the case of using water. In general, if water is used as the dispersion medium, the resin emulsion is referred to as an aqueous emulsion or oil in water emulsion. If a solvent other than water is used as the dispersion medium, the resin emulsion is referred to as non-water dispersion type emulsion (NAD) or oil in oil type emulsion.

The resin emulsion for use in the present disclosure is defined as an article in which water-insoluble resin particulates are stably dispersed in water or a dispersion medium including an organic solvent as the main component. If the water-insoluble resin particulates are solid, it is contained in a dispersed form in the dispersion medium. If the water-insoluble resin particulates are liquid, it is contained in an emulsion form in the dispersion medium. In the present disclosure, it is more preferable that the water-insoluble resin particulates be emulsified in a dispersion medium.

In the step of forming the coating material with the resin emulsion, for example, if a resin emulsion including the water-insoluble resin particulates is applied to the surface of the core material, the water-insoluble resin particulates wet-spread on the surface of the core material and thereafter the dispersion medium component contained in the resin emulsion evaporates. As a result, the water-insoluble resin particulates are condensed and closely packed. As drying proceeds furthermore and when the temperature reaches the minimum film-forming temperature (MFT) or higher, the water-insoluble resin particulates are deformed and fill the space between the particulates. The particulates closely in contact are fused due to counter diffusion and form a polymer block to form a coating material.

The methods of emulsifying the water-insoluble resin particulates are typified into methods of emulsifying resin particulates into which hydrophilic groups or hydrophilic segments are introduced in a dispersion medium (self emulsification) and methods of emulsifying resin particulates in a dispersion medium by a surfactant (forced emulsification). The self emulsification is preferable in the present disclosure.

A self-emulsification type resin emulsion improves wettability of the resin emulsion to the surface of the core material having hydrophilicity and the resin particulates uniformly wet-spread on the surface of the core material. As a result, the attachability between the core material and the film formed of the coating material is improved, thereby preventing peeling-off. In addition, the film thickness can be made uniform, which makes it possible to prevent moisturization before melting and discharging and demonstrate the effect of dissolution in water after melting and discharging. Furthermore, controlling the particle diameter of resin particulates is possible and dispersion stability is improved.

When the forced emulsion is used, wettability onto the core material can be improved by a surfactant contained. However, the surfactant bleeds out to the surface during or after drying so that attachability of the film formed of core material deteriorates and the film is peeled off from the core material or the film thickness is uneven. For this reason, the moisturization prevention and dissolution in water may not strike the balance.

With regard to the hydrophilic group introduced into the self emulsification type resin particulates, the hydrophilic group is typified into anionic, cationic, and nonionic in terms of ion property. Specific examples of the anionic hydrophilic group includes, but are not limited to, a carboxyl group or a sulfo group.

Specific examples of the cationic hydrophilic group includes, but are not limited to, an amino group or an ammonium group. A specific example of the nonionic hydrophilic group is a hydroxyl group. In the present disclosure, of these hydrophilic groups, anionic hydrophilic groups are more preferable.

In addition to the hydrophilic group, a reaction group can be introduced into the water-insoluble resin particulates for use in the present disclosure for cross-linking. For this reason, the film intensity can be improved, which is advantageous to enhance the moisturization prevention of the core material.

Usable resins as the resin emulsion can be any known resins. The water-insoluble resins mentioned above are preferable and urethane resins, acrylic resins, polyester resins, epoxy resins, olefin resins, and copolymers thereof are particularly preferable. Of these, urethane resins and acrylic resins are preferable.

Urethane resins is a generic term for polymers having many urethane bonds. In the present disclosure, the urethane resin includes resins modified by an acrylic resin, an alkyd resins, an epoxy resin, etc. Acrylic resins are a generic term for simple esters or copolymers of acrylic acid or methacrylic acid and include copolymers with various polymers and oligomers and modified articles.

The resin particulate mentioned above preferably has a good film forming ability to form the coating material on the surface of the core material as described above. When using a resin having a poor film forming ability, for example, it is possible to use a structure including a soft segment having a non-crystalline portion having a weak agglomerating power and a hard segment having a crystal portion having a strong agglomerating power. For example, the basic structure of the urethane resin includes a soft segment having a non-crystalline portion having a weak agglomerating power, mainly of polyol, and a hard segment having a crystalline portion having a strong agglomerating power mainly of urethane bond or urea bond. This structure imparts flexibility, softness, bending property, toughness, heat resistance, abrasion resistance, etc. to keep these conflicting properties in proper balance, which is preferable for the present disclosure.

In addition, the resin contained in these resin emulsion can be preliminarily cross-linked like a network to form a polymerized internal cross-linking structure. For example, since the inside of the resin particulate of the resin emulsion can be polymerized by cross-linking during emulsion polymerization, thereby enhancing durability. This is preferable to maintain moisturization prevention for an extended period of time.

Moreover, resin particulates having a core-shell structure are also known. This is suitably used in the present disclosure. Such resin particulates include a polymer at the core portion and a hydrophilic group or hydrophilic structure at the shell portion, which improves dispersion stability and uniformity of particle diameter of the resin particulate. This is good to improve moisturization prevention. Moreover, resin particulates which are melt-fused and self-cross-linked at the same time in the drying process or cross-linked upon irradiation of ultraviolet are preferable in the present disclosure.

The resin emulsions are available on the market and can be suitably used in the present disclosure.

Specific examples of the urethane resin emulsion include, but are not limited to, SUPERFLEX series of 110, 126, 130, 150, 150HS, 170, 300, 420, 460, 470, 740, 800, 820, 830, 840, 860, and 870, SUPERFLEX E series of E-2000, E-4000, and E-4800, and SUPERFLEX R series of R-5002 (all manufactured by DKS Co. Ltd.), PERMARIN series of PERMARIN UA-310 and UA-368, UCOAT series of US-230, and UPRENE series of

UPRENE UXA-307 (manufactured by Sanyo Chemical Industries, Ltd.), ADEKA BONTIGHTER HUX series of ADEKA BONTIGHTER HUX-290H, ADEKA BONTIGHTER HUX-395D, ADEKA BONTIGHTER HUX-394, ADEKA BONTIGHTER HUX-232, ADEKA BONTIGHTER HUX-240, ADEKA BONTIGHTER HUX-320, ADEKA BONTIGHTER HUX-350, ADEKA BONTIGHTER HUX-380, ADEKA BONTIGHTER HUX-381, ADEKA BONTIGHTER HUX-388, ADEKA BONTIGHTER HUX-380A, ADEKA BONTIGHTER HUX-386, ADEKA BONTIGHTER HUX-575, ADEKA BONTIGHTER HUX-580, ADEKA BONTIGHTER HUX-822, ADEKA BONTIGHTER HUX-930, etc. (manufactured by ADEKA CORPORATION), and WBR series of WBR-016U, WBR-2018, WBR-2000U, and WBR-2101, and WAN series of WAN-6000 and WAN-1000U (manufactured by TAISEI FINE CHEMICAL CO., LTD.). These urethane resin emulsion can be used alone or in combination. In addition, the urethane resin emulsion can be mixed with another resin-based emulsion.

Specific examples of the acrylic resin emulsion include, but are not limited to, Vinyblan series of 2682, 2680, 2684, 2685, and 2687 (manufactured by Nisshin Chemical Co., Ltd.), ARON® series of A-104, A-106, and NS-1200 (manufactured by TOAGOSEI CO., LTD.), and 3MF series of 3MF-3095, 3MF--320, 3MF-333, 3MF-407, 3MF-574, and 3MF-587 (manufactured by TAISEI FINE CHEMICAL CO., LTD.).

Specific examples of the core-shell type resin emulsion include, but are not limited to, anion-based SE series of SE-810A, SE-841A, SE-953A-2, SE-1658F, cation-base self cross-linking type nanoemulsion of UW series of UW-319SX, US-600, and US-550CS, organic-inorganic hybrid emulsion of KS series of KS-3705, amphoteric-based RKW series of RKW-500, AKW series of AKW-107, acrylic-urethane hybrid type WEM series of WEM-031U, WEM-200U, WEM-321U, WEM-3000, and WEM-290A (manufactured by TAISEI FINE CHEMICAL CO., LTD.).

These acrylic resin emulsion can be used alone or in combination. In addition, the acrylic resin emulsion can be mixed with another resin-based emulsion.

Moreover, specific examples of the aqueous polyester resin emulsion include, but are not limited to, ELITEL® series, KA series, and KT series (manufactured by UNITIKA

LTD.). Specific examples of the aqueous epoxy resin emulsion include, but are not limited to, ADEKA Resin EM series (manufactured by ADEKA CORPORATION).

Specific examples of the aqueous polyolefin resin emulsion include, but are not limited to, Arrow Base series of Arrow Base D series (manufactured by UNITIKA LTD.), CHEMIPEARL™ series (manufactured by Mitsui Chemicals, Inc.), and VESTPLAST series (manufactured by Evonik Industries AG). However, these are mere examples and not limiting the present disclosure.

Liquid application or emulsion to form the coating material for use in the present disclosure may optionally include various additives in addition to the resins mentioned above to form a film.

Examples are defoaming agents, foaming agents, viscosity modifiers, dispersants, stabilizing agents, antioxidants, pH regulators, cross-linking agents, ultraviolet absorbers, antistatic agents, fillers, flame retardants, lubricants, coloring materials (colorants), and pigments.

A liquid composition in which the water-insoluble resin mentioned above, particulates thereof, and other components are dissolved, dispersed, or emulsified in water or a dispersion medium other than water is used as a liquid application to form a film.

The average primary particle diameter of the resin emulsion mentioned above and the resin particulates contained in the liquid application for use in the present disclosure is preferably 0.005-5.0 μm, more preferably 0.01-1.0 μm, and furthermore preferably 0.02-0.5 μm. When the average primary particle diameter of the resin particulates is not less than 0.005 μm, the film strength is improved and moisturization prevention is enhanced. On the other hand, when the average primary particle diameter of the resin particulates is not more than 5.0 μm, the core material and the coating material formed on the surface of the core material adhere to each other better, thereby preventing peeling-off the film and invasion of water inside the film.

Since the film thickness of the coating material formed on the surface on the core material varies depending on the property of a resin for use in the coating material, the thickness is arbitrarily selected to suit to a particular application. In general, the thickness is preferably 0.01-100 μm, more preferably 0.1-50 μm, and furthermore preferably 0.01-100 μm,1-10 μm. When the film thickness of the coating material is not less than 0.01 μm, moisturization prevention is improved. When the thickness is not greater than 100 μm, water-solubility is improved after melt-fusion and discharging when used as a supporting material so that the supporting material is easily and quickly removed.

Method of Manufacturing Solid Freeform Fabrication Material

The core material is a molded material including a water-soluble resin before forming the coating material mentioned above as the main component and may include various resins and additives as well as the thermoplastic resins having water-solubility mentioned above. The core material is prepared by melt-kneading the thermoplastic resins having water-solubility mentioned above and other components and extruding and shaping the resultant to have a various form such as a filament-like form and a pellet-like form using a known method.

The constitutional material is melt-kneaded by a method of melt-kneading per batch using a melt-kneader device or a screw-extruder having a short shaft or twin shaft, a kneader, or a mixer. The melt-kneaded resin composition is, for example, extruded and shaped and thereafter finely severed to obtain a solid freeform fabrication material having a pellet-like form. In addition, after obtaining a pellet-like form, for example, a solid freeform fabrication material having a filament-like form can be obtained by melting raw material by heat and extruding the melted raw material through a cap to obtain a filament-like form followed by cooling down to solidify the material having the fiber-like form (melt-spinning method), dissolving raw material in a solvent vaporized by heat, extruding from a cap in a heat atmosphere to evaporate the solvent to obtain a fiber-like form (dry spinning method), and dissolving raw material in a solvent and extruding from a cap in the solution to conduct chemical reaction followed by removing the solvent to form a filament-like form (wet spinning method).

When shaping into a filament-like form, the diameter of the filament is not particularly limited. For example, it is 0.5-5.0 mm and preferably 1.0-3.0 mm.

As described above, the solid freeform fabrication material of the present disclosure is a shaped material in which a water-insoluble coating material is formed on the surface of the core material. For example, the solid freeform fabrication material of the present disclosure can be manufactured by coating the surface of the core material with a liquid composition including the water-insoluble resin and other components.

The liquid composition (liquid application or emulsion) can be formed on the surface of the core material by a known method. For example, spray coating, dip coating, and flow coating are suitable but the method is not limited thereto.

As described above, after forming the coating material on the surface of a core material, the film is dried. In the step of evaporating a dispersion medium contained in the film, the resin particulates are closely-packed and thereafter the film is formed. Therefore, the drying process has an impact on the quality of the solid freeform fabrication material. The liquid application of an emulsion has a minimal film-forming temperature (MFT) defined as the temperature required to form film of the emulsion. It is suitable to dry the film at temperatures higher than the MFT. To aggregate the resin particulate and form a single resin film as described above, adhesion of resin particulates is required. The MFT is suitably set depending on a resin or an emulsion to be used. In general, it is 0-100 degrees C. The film intensity is better as the drying temperature rises.

Method of Manufacturing Solid Freeform Fabrication Object

In the method of manufacturing a solid freeform fabrication object of the present disclosure, a solid freeform fabrication object is obtained by shaping the solid freeform fabrication material of the present disclosure by using a known solid freeform fabrication device. The solid freeform fabrication device includes a device to heat and melt a thermoplastic resin and repeats discharging the heated and melted solid freeform fabrication material freely at arbitrary positions for lamination. It is possible to use any known device. For example, a known solid freeform fabrication device employing a fused deposition modeling (FDM) method is suitable. The method of manufacturing a solid freeform fabrication object using such a solid freeform fabrication device includes heating and melting the solid freeform fabrication material of a thermoplastic resin while extruding the solid freeform fabrication material, thereafter discharging it at arbitrary positions through a head nozzle, cooling and solidifying the material, and repeating these steps to sterically laminate the material.

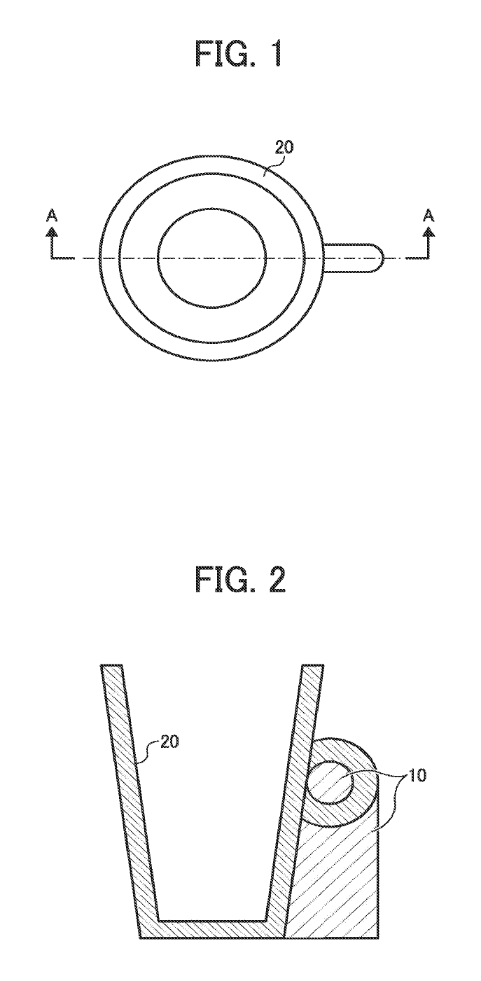

The method of manufacturing a solid freeform fabrication object using a supporting member is described with reference to FIGS. 1, 2, and 3. FIGS. 1 to 3 are schematic diagrams illustrating an example of the method of manufacturing a solid freeform fabrication object.

When using a supporting material, for example, at least two head nozzles are used to separate one for the supporting material from the other for modeling. FIG. 1 is a diagram illustrating a planar view of the solid freeform fabrication object including the supporting material. FIG. 2 is a diagram illustrating a cross section of A-A line.

When manufacturing a solid freeform fabrication object having a form illustrated in

FIG. 1, a modeling material 20 and a supporting material 10 illustrated in FIG. 2 are repeatedly laminated by the method described above to obtain a united solid freeform fabrication object fabricated by the modeling material 20 and the supporting material 10. Without the supporting material 10, it is not possible to aesthetically shape the handle portion.

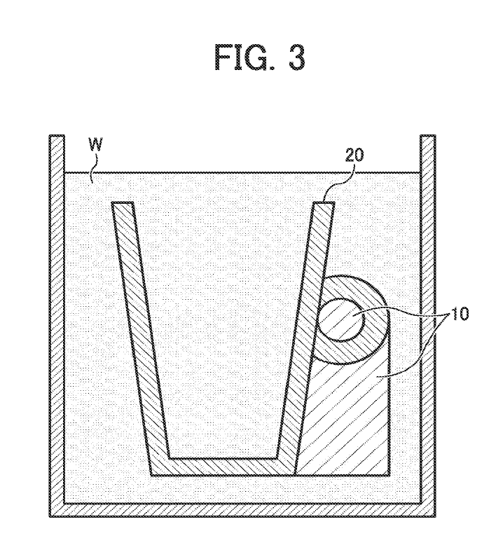

FIG. 3 is a diagram illustrating an example of the method of removing the supporting material 10 from the obtained united solid freeform fabrication object. When the solid freeform fabrication object is dipped in a vessel filled with water or lukewarm water, only the supporting material 10 is dissolved in the water or the lukewarm water so that the supporting material 10 can be completely removed to obtain a solid freeform fabrication object fabricated by the modeling material 20.

The supporting material for use in the present disclosure demonstrates moisturization prevention by the coating material formed on the surface before the supporting material is dissolved. However, after it is melted and discharged, the coating material is also dissolved so that moisturization prevention is lost. As a consequence, water-solubility becomes high. Therefore, when the solid freeform fabrication object formed of the modeling material and the supporting material is dipped in water or lukewarm water, only the supporting material is dissolved. That is, the supporting material can be easily and quickly removed. In conclusion, it is possible to strike a balance between prevention of defective modeling caused by moisture absorption during usage or storage of a supporting material and shortening of removal time of the supporting material.

This configuration is a solid freeform fabrication material set including the solid freeform fabrication material of the present disclosure as the supporting material 10 and a water-insoluble solid freeform fabrication material as the modeling material 20. The water-insoluble solid freeform fabrication material preferably includes a thermoplastic resin.

The temperature at which the solid freeform fabrication material is melted is set to be the melting temperature of the head nozzle in the solid freeform fabrication device. It is preferable that both of the core material and the coating material the solid freeform fabrication material includes be melted at this melting temperature. If this set temperature is higher than the melting point of the core material and the coating material, moisturization prevention is lost after melted and discharged, the removal of the supporting material is easy.

For example, when the thermoplastic resin contained in the core material of a solid freeform fabrication material is a polyvinyl alcohol, the melting point is 150-240 degrees C. Therefore, it is preferable to set the temperature within this temperature range. If the temperature is set too high and the polyvinyl alcohol resin is decomposed, nozzle clogging may occur, which degrades fabrication stability and accuracy.

In addition, when the solid freeform fabrication material of the present disclosure has a filament-like form and the material is melted by heat and thereafter discharged from a nozzle orifice in the heating and melting step to manufacture a solid freeform fabrication material, it is preferable that the inner diameter of the nozzle orifice be smaller than the outer diameter of the core material portion of the filament. In that case, the coating material on the surface of the filament formed before discharged through a nozzle orifice is mostly removed from the surface after the discharging. Therefore, the surface of the filament is mostly covered with the core material. For this reason, prior to discharging, since the coating material is formed on the surface, moisture absorption by the core material is prevented while the surface of the solid object is mostly covered with the core material so that the object demonstrates high water-solubility. Therefore, the supporting material is easily and quickly removed.

If the solid freeform fabrication material of the present disclosure is not dehumidified prior to use as the supporting material, it is possible to fabricate a solid freeform fabrication object with good stability and accuracy. The supporting material is easily, quickly, and safely removed by attaching water or lukewarm water to the thus-obtained solid freeform fabrication object.

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, embodiments of the present disclosure are described in detail with reference to Examples but not limited thereto.

### Example 1

Manufacturing of Filament Shaped Material

Pellets of the following water-soluble resin was extruded by an extruder (filament extruder Noztek Pro for 3D printer) at a melting temperature set to 200 degrees C. to obtain a filament-shaped material having a diameter of 1.75 mm.
Water-soluble resin: Polyvinyl alcohol (Nichigo G-Polymer, OKS-8150P, manufactured by The Nippon Synthetic Chemical Industry Co., Ltd.)

Manufacturing of Filament Shaped Material for Solid Freeform Fabrication

The surface of the filament-shaped material was uniformly spray-coated with an emulsion including particulates of the following resin having a hydrophilic group, naturally dried, dried at 80 degrees C. for three hours, and furthermore dried at 110 degrees C. for 15 minutes to form a film having a thickness of about 10 μm. Thus, a filament-shaped material 1 for solid freeform fabrication of the present disclosure was manufactured.
Resin having a hydrophilic group: Aqueous urethane resin emulsion (SUPERFLEX 800, non-volatile portion: 34-36 percent by mass, anionic, average primary particle diameter: 0.03 μm, minimal film-forming temperature: 35 degrees C., film heat-melting temperature: 125 degrees C., manufactured by DKS Co. Ltd.).

### Example 2

A filament-shaped material 2 for solid freeform fabrication was manufactured in the same manner as in Example 1 except that the water-soluble resin of the filament-shaped material of Example 1 was changed to the following.
Water-soluble resin: Polyvinyl alcohol (G-Polymer-OKS-8164P, manufactured by The Nippon Synthetic Chemical Industry Co., Ltd.)

### Example 3

A filament-shaped material 3 for solid freeform fabrication was manufactured in the same manner as in Example 1 except that the water-soluble resin of the filament-shaped material of Example 1 was changed to the following.
Water-soluble resin: Polyvinyl alcohol (G-Polymer-OKS-8049, manufactured by The Nippon Synthetic Chemical Industry Co., Ltd.)

### Example 4

A filament-shaped material 4 for solid freeform fabrication was manufactured in the same manner as in Example 1 except that the water-soluble resin of the filament-shaped material of Example 1 was changed to the following.
Water-soluble resin: Polyvinyl alcohol (CP-1210, manufactured by KURARAY CO., LTD.)

### Example 5

A filament-shaped material 5 for solid freeform fabrication was manufactured in the same manner as in Example 1 except that the water-soluble resin of the filament-shaped material of Example 1 was changed to the following.
Water-soluble resin: Polyvinyl alcohol (PVA205, manufactured by KURARAY CO., LTD.)

### Example 6

A filament-shaped material 6 for solid freeform fabrication was manufactured in the same manner as in Example 1 except that the water-soluble resin of the filament-shaped material of Example 1 was changed to the following.
Water-soluble resin: Polyethylene oxide (ALKOX, manufactured by Meisei Chemical Works, Ltd.)

### Example 7

A filament-shaped material 7 for solid freeform fabrication was manufactured in the same manner as in Example 1 except that the water-soluble resin of the filament-shaped material of Example 1 was changed to the following.
Water-soluble resin: Polyethylene oxide (PEO-2, manufactured by SUMITOMO SEIKA CHEMICALS CO., LTD.)

Manufacturing of Solid Freeform Fabrication Object

A solid freeform fabrication object was manufactured from the filament-shaped materials for solid freeform fabrication of Examples by the following solid freeform fabrication device.
Solid freeform fabrication device: CREATR HS (available from Leapfrog)
Head nozzle melting temperature: 200-220 degrees C.

Evaluation of Fabrication Stability

After the modeling material and the supporting material of the filament-shaped material for solid freeform fabrication were left at 35 degrees C. and 60 percent RH for five days, the solid freeform fabrication object illustrated in FIG. 1 was manufactured using the solid freeform fabrication device mentioned above.

Fabrication stability was evaluated by checking whether fabrication was halted in the middle due to conveying defects or discharging defects of the filament. The evaluation was conducted according to the following criteria.
E (Excellent): Solid freeform fabrication object was manufactured from beginning to end without a stop
G (Good): Fabrication was halted once or twice but resumed soon and solid freeform fabrication object was manufactured
M (Marginal): Fabrication stopped frequently and fixed every time to manufacture solid freeform fabrication object
P (Poor): Fabrication stopped soon after the initiation of the fabrication and failed to manufacture a solid freeform fabrication object

Evaluation on Fabrication Accuracy

After the modeling material and the supporting material of the filament-shaped material for solid freeform fabrication were left at 35 degrees C. and 60 percent RH for five days, the solid freeform fabrication object illustrated in FIG. 1 was manufactured using the solid freeform fabrication device mentioned above.

Fabrication accuracy was evaluated by visually observing the thus-obtained solid freeform fabrication object to check whether there was a defect. The evaluation was conducted according to the following criteria.
E (Excellent): Target solid freeform fabrication object obtained free of conspicuous defects
G (Good): A few defects were found but causing no practical problem
M (Marginal): Many defects were found and apparently accuracy was low
P (Poor): Away from target shape, not possible to recognize target shape of object

Test for Removing Supporting Material

The thus-obtained solid freeform fabrication object was dipped in lukewarm water at 50 degrees C. While stirring the lukewarm water, the time was measured when the supporting material was completely removed. The evaluation was conducted according to the following criteria.
E (Excellent): Completely removed within one hour of dipping
G (Good): Completely removed within three hours of dipping
M (Marginal): Supporting material still remained five hours after start of dipping and was able to be scraped off
P (Poor): Supporting material still remained 24 hours after start of dipping

The results are shown in Table 1.

TABLE 1

| | | | | | Removal |
|---|---|---|---|---|---|
| | Water- | Resin having | Fabrica- | Fabrica- | of sup- |
| | soluble | hydrophilic | tion | tion | porting |
| | resin | group | stability | accuracy | member |
| Example 1 | OKS-150P | SUPERFLEX | E | E | E |
| | | 800 | | | |
| Example 2 | OKS- | SUPERFLEX | E | E | E |
| | 8164P | 800 | | | |
| Example 3 | OKS-8049 | SUPERFLEX | E | E | G |
| | | 800 | | | |
| Example 4 | CP-1210 | SUPERFLEX | E | E | G |
| | | 800 | | | |
| Example 5 | PVA205 | SUPERFLEX | G | E | G |
| | | 800 | | | |
| Example 6 | R-1000 | SUPERFLEX | E | E | E |
| | | 800 | | | |
| Example 7 | PEO-2 | SUPERFLEX | G | E | E |
| | | 800 | | | |

DSC

The polyvinyl alcohol resins mentioned above were subject to differential scanning calorimetry (DSC) under the following conditions to measure the melting points. The melting pint was obtained by the peak of endothermic peaks. The results are shown in Table 2.
Device: DSC-60A, manufactured by Shimadzu Corporation
Heating speed: 10 degrees C/min
Measuring range of temperature: 40-400 degrees C.

TG-DTA

The polyvinyl alcohol resins mentioned above were subject to thermogravimetry-differential thermal analysis (TG-DTA) under the following conditions to measure the temperature at which 10 percent of mass was reduced. The temperature at which 10 percent of mass was reduced was the temperature at which 10 percent of the mass was reduced to the mass of the obtained TG curve at 100 degrees C. The results are shown in Table 2.
Device: DTG-60, manufactured by Shimadzu Corporation
Heating speed: 10 degrees C/min
Measuring range of temperature: 40-500 degrees C.

TABLE 2

| | | Temperature at | |
|---|---|---|---|
| | | which 10 percent | Temperature |
| | Melting point | of mass reduced | difference |
| PVA | (degrees C.) | (degrees C.) | (degrees C.) |
| 8150P | 174 | 314 | 140 |
| 8164P | 170 | 312 | 142 |
| 8049 | 186 | 322 | 136 |
| CP1210 | 161 | 297 | 136 |
| PVA205 | 194 | 301 | 107 |

As seen in Table 1, the filament-shaped material for solid freeform fabrication for use in the present disclosure suppresses degradation of fabrication stability and fabrication accuracy caused by moisture absorption during storage or usage of the filament-shaped material without having an adverse impact on the properties of the filament-shaped material.

According to the present disclosure, a solid freeform fabrication material is provided which can suppress degradation of fabrication stability and fabrication accuracy ascribable to moisture absorption during storage or usage of the solid freeform fabrication material without an adverse impact on properties of a solid freeform fabrication material.

Having now fully described embodiments of the present invention, it will be apparent to one of ordinary skill in the art that many changes and modifications can be made thereto without departing from the spirit and scope of embodiments of the invention as set forth herein.

What is claimed is:

1. A solid freeform fabrication material comprising:
a water-soluble core material; and
a water-insoluble coating material formed on a surface of the water-soluble core material

2. The solid freeform fabrication material according to claim 1, wherein a melting point of the water-soluble core material is equal to or higher than a melting point of the water-insoluble coating material.

3. The solid freeform fabrication material according to claim 1, wherein the water-soluble core material includes polyvinyl alcohol.

4. The solid freeform fabrication material according to claim 1, wherein the water-insoluble coating material includes a hydrophilic group.

5. A solid freeform fabrication material set comprising:
the solid freeform fabrication material of claims 1; and
a water-insoluble solid freeform fabrication material.

6. A method of manufacturing a solid freeform fabrication object comprising:
heating and melting a solid freeform fabrication material including a water-soluble core material and a water-insoluble coating material formed on a surface of the water-soluble core material; and
manufacturing the solid freeform fabrication object with the solid freeform fabrication material.

7. The method according to claim 6, wherein the manufacturing manufactures the solid freeform fabrication object using the solid freeform fabrication material as a supporting material, the method further comprising:
removing a portion of the supporting material from the solid freeform fabrication object after the manufacturing.

8. The method according to claim 6, wherein a heating and melting temperature in the heating and melting is equal to or higher than each of a melting point of the water-soluble core material and a melting point of the water-insoluble coating material.
